(19) United States
(12) Patent Application Publication
(10) Pub. No.: US 2012/0038563 A1
(43) Pub. Date: Feb. 16, 2012

(54) TOUCH PANEL AND ELECTRONIC DEVICE INCLUDING THE SAME

(75) Inventors: Sung-Hyuk PARK, Yongin-si (KR); Seong-Taek LIM, Suwon-si (KR)

(73) Assignee: SAMSUNG ELECTRONICS CO., LTD., Suwon-si (KR)

(21) Appl. No.: 13/097,937

(22) Filed: Apr. 29, 2011

(30) Foreign Application Priority Data
Aug. 12, 2010 (KR) 10-2010-0078011

(51) Int. Cl. G06F 3/041

(52) U.S. Cl. 345/173

(57) ABSTRACT

Provided are a touch panel and an electronic device including the same. The touch panel includes a pair of upper and lower substrates spaced apart from each other by a gap, wherein the upper substrate has a user touch surface. Electro-rheological fluid fills the gap between the upper and lower substrates. The touch panel includes a determining unit which senses a contact or pressing operation on the user contact surface to determine an input type, and which sets a predetermined activation force value according to the input type to determine whether an input occurs. The touch panel may further include a controller which applies a driving voltage, when the determining unit determines that an input according to a corresponding input type occurs.

### CROSS-REFERENCE TO RELATED APPLICATION

This application claims priority from Korean Patent Application No. 10-2010-0078011, filed on Aug. 12, 2010 in the Korean Intellectual Property Office, the entire disclosure of which is incorporated herein in its entirety by reference.

### BACKGROUND

1. Field

Apparatuses consistent with exemplary embodiments relate to a user's input device, and more particularly, to a touch panel and an electronic device including the same.

2. Description of the Related Art

A touch panel is a type of user input device used to determine whether a user generates an input signal and the position of the user's input signal by sensing the user's contact thereon. A user may input data or signals to a touch panel by contacting or pressing the touch panel with his or her finger, a stylus pen or the like. Recently, a continuous input function, such as flick, drag, scroll, pinch, tap-and-slide and the like, allowing users to continue to contact or press a touch panel surface is widely used in a touch panel. Such a continuous input is a type of multi-touch input.

The touch panel may be used as a touch pad which substitutes for a mouse in a laptop computer, a netbook, etc., or may substitute for an input switch of an electronic device. Also, the touch panel may be used in connection with a display. A touch panel which is mounted on the screen of a display, such as Liquid Crystal Display (LCD), Plasma Display Panel (PDP), Cathode Ray Tube (CRT) and the like, is called a “touch screen”. A touch panel may be integrated with a display to configure the screen of the display or may be attached additionally on the screen of the display.

The touch panel can be substituted for a user input device such as a keyboard and also allow simple manipulations. Moreover, the touch panel can provide users with various types of buttons according to the types of applications to be executed or stages of the executed application. Accordingly, a touch panel, specifically, a touch screen has been widely used as an input device for electronic equipment, such as a mobile phone, a Personal Digital Assistant (PDA), a Portable Multimedia Player (PMP), a digital camera, a portable game, an MP3 player, etc., as well as an Automated Teller Machine (ATM), an information trader, a ticket vending machine, etc.

A touch panel can be classified into a resistive film type, a capacitive type, a saw type, an infrared type, etc., according to methods of sensing user's inputs. However, the existing touch panels fail to offer users a sense of input, that is, a feeling of recognition that a user gets when pressing a mechanical keypad. In order to overcome this disadvantage, a method of installing a vibration motor below a touch panel has been proposed. The method offers users a sense of input by vibrating the whole touch panel using the vibration motor when a user's contact is sensed. However, the sense of input transferred through vibration of a touch panel is different from a sense of input that a user gets when pressing a mechanical keypad.

A capacitive type touch panel has a relatively small activation force or small activation force value, and a resistive film type touch panel has a relatively great activation force or great activation force value. The “activation force” is a minimum force by which a touch panel can recognize or detect an input. That is, an input occurs when a force exceeding an activation force is applied onto the touch panel. A touch panel having a small activation force offers users a soft sense of input but may cause input errors due to proximity sensing. A touch panel having a great activation force cannot offer users a soft sense of input although the possibility of input errors is low.

### SUMMARY

One or more embodiments relate to a touch panel that can prevent input errors, and offer a user a soft sense of input according to the types of applications or input operations, as well as a clicking sensation like when pressing a mechanical keypad, and an electronic device including the touch panel.

According to an aspect of an embodiment, there is provided a touch panel including a first substrate, a second substrate, electro-rheological fluid, and a determining unit. The second substrate is spaced apart from the first substrate by a predetermined gap and includes a user touch surface thereon. The electro-rheological fluid fills the gap between the first substrate and the second substrate. The determining unit senses a contact or a pressing operation on the user touch surface and determines an input type. The determining unit further sets a predetermined activation force value according to the input type to determine whether an input occurs.

According to an aspect of another embodiment, there is provided a touch panel including a first substrate, a second substrate, an array of driving electrode pairs, electro-rheological fluid, a sealant, a plurality of spacers, and a determining unit. The second substrate is spaced apart from the first substrate by a predetermined gap and includes a user touch surface thereon. The array of driving electrode pairs includes a plurality of first electrodes formed on the first substrate and a plurality of second electrodes formed on the second substrate. The array of driving electrode pairs forms an electric field in the gap between the first substrate and the second substrate when a driving voltage is applied to all or a portion of the plurality of first electrodes and the plurality of second electrodes. The electro-rheological fluid fills the gap between the first substrate and the second substrate, and the viscosity of the electro-rheological fluid increases due to the electric field. The sealant is applied onto facing edge portions of the first and second substrates and seals the electro-rheological fluid. The plurality of spacers are disposed on the first substrate and include a material having elasticity. The determining unit senses a contact or a pressing operation on the user touch surface to determine an input type, and sets a predetermined activation force value according to the input type to determine whether an input occurs.

According to an aspect of another embodiment, there is provided a touch panel including a first substrate, a second substrate, electro-rheological fluid, a pulse generating circuit, a pulse applying circuit, and a sensing circuit unit. On the first substrate, M first electrode lines are arranged in a first direction, wherein M is an integer greater than 2, and on the second substrate separated apart from the first substrate, N second electrode lines are arranged in a second direction orthogonal to the first direction, wherein N is an integer greater than 2. The electro-rheological fluid fills the gap between the first substrate and the second substrate. The pulse generating circuit unit generates a driving pulse voltage for driving the electro-rheological fluid and a sensing pulse voltage for determining whether an input occurs. The pulse applying circuit unit integrates the driving pulse voltage with the sensing pulse voltage to apply the integrated voltage to the M first electrode lines. The sensing circuit unit measures capacitance at each of intersections of the M first electrode lines and the N second electrode lines in response to the sensing pulse voltage to determine whether an input occurs, wherein different criteria values are applied according to input types to determine whether an input occurs.

### BRIEF DESCRIPTION OF THE DRAWINGS

The above and/or other aspects will be more apparent by describing certain embodiments with reference to the accompanying drawings, in which:

FIG. 1 is a diagram illustrating a touch panel according to an embodiment;

FIG. 2 is an exploded perspective view illustrating a touch panel body of the touch panel illustrated in FIG. 1 according to an embodiment;

FIG. 3 is a cross-sectional view cut along a line III-III′ of FIG. 2;

FIG. 4 is a cross-sectional view illustrating a touch panel body according to another embodiment;

FIG. 5A is a graph showing the relationship between force and displacement of a mechanical key button;

FIG. 5B is a graph showing the relationship between force and displacement of the touch panel;

FIG. 6 is a graph showing timings at which a driving voltage is applied to and released from the touch panel;

FIG. 7 illustrates a circuit structure diagram for the touch panel according to an embodiment;

FIG. 8 illustrates an exemplary timing chart of a driving voltage Vd and a sensing pulse voltage Vs that are applied to row electrode lines R1 through R9 illustrated in FIG. 7;

FIG. 9A is a circuit diagram illustrating a sensing circuit unit illustrated in FIG. 7 according to an embodiment;

FIG. 9B is a timing chart showing input and output voltages at terminals \textcircled{a},\textcircled{b} and \textcircled{c} of the circuit illustrated in FIG. 9A when the type of input is a click input;

FIG. 9C is a timing chart showing input and output voltages at terminals \textcircled{a}, \textcircled{b} and \textcircled{c} of the circuit illustrated in FIG. 9A when the type of input is a continuous input;

FIG. 10 is a cross-sectional view illustrating a touch panel body according to an embodiment;

FIG. 11 is a graph showing changes in repulsive force with respect to displacement of upper substrates in touch panels with different gap thicknesses between the upper substrates and spacers;

FIG. 12 is a cross-sectional view illustrating a touch panel body;

FIG. 13A is a graph showing changes in repulsive force with respect to displacement of upper substrates in touch panels with different shapes of spacers; and

FIG. 13B is an enlarged view of a part surrounded by a dotted circle of FIG. 13A.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

A touch panel which will be described in this specification may be used as a user input device of an electronic device that can sense continuous contacts or pressing operations (hereinafter, simply referred to as a “continuous input”) as well as a single contact or pressing operation (hereinafter, simply referred to as a “click input”) from a user through a user touch surface to execute a predetermined instruction. That is, a user may perform a click input or a continuous input on a touch panel to input a predetermined instruction to an electronic device including a touch panel. As such, the electronic device including the touch panel may recognize both a continuous input and a click input as inputs. However, the electronic device may recognize only one of a continuous input and a click input as an input according to the type and/or processing stage of an application.

The click input indicates an input of once contacting or pressing a user touch surface for a predetermined time without changing the input location. The continuous input indicates an input of moving the input location along a predetermined path for a predetermined time. The continuous input is different from repeatedly tapping a specific location on a touch panel, continuing to contact or press a specific location on a touch panel for a predetermined time, or discontinuously contacting or pressing a user touch surface on a touch panel although the contact or pressed location moves on the user touch surface, etc.

In the following description, details about the movement path of an input location upon a continuous input, the movement distance and speed of the continuous input, what instruction for an electronic device the continuous input functions as, etc. are irrelevant to touch panels according to embodiments described herein. For example, the movement path of a continuous input may be along a horizontal, vertical, diagonal, zigzag or back-and-forth direction. Also, an input using two fingers at once, like pinch, and a combination input consisting of two or more inputs such as tapping also may be a continuous input when the inputs are combined with operation in which an input location continues to change over time. Further, the continuous input may be recognized as a predetermined instruction in association with a displayed screen as well as simply in association with a gesture. For example, upon dragging and dropping a certain displayed object (for example, a file) or scrolling a scroll bar up and down and/or left and right, moving a playing time adjusting bar or a volume adjusting bar back and forth or up and down also may be a continuous input.

The touch panel may be included as a user input device in various kinds of electronic devices. For example, the touch panel may be used as a touch pad or touch screen of a laptop computer or netbook computer, etc., and as an input device in various kinds of home or office appliances, etc., which can process a continuous input function. Also, the touch panel may be mounted on the upper part of a display of an electronic device and used as a touch screen. For example, the touch screen may be used as a touch screen of an electronic device, such as a mobile phone, PDA, PMP, an E-book terminal, a laptop computer, a tablet computer, an ATM, an MP3 player, an information trader, a ticket vending machine, or the like.

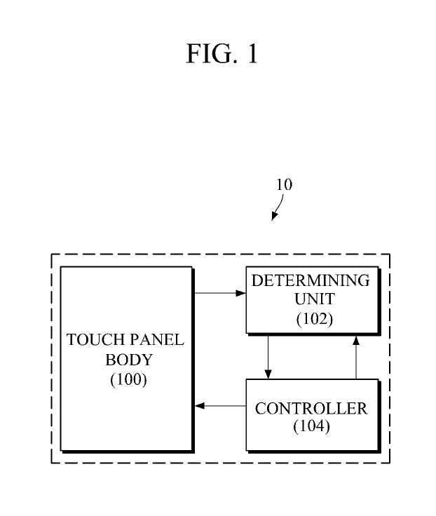

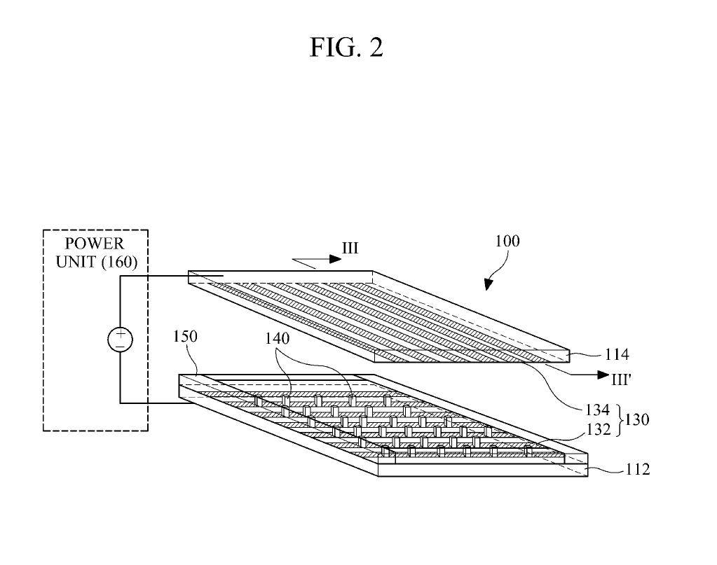

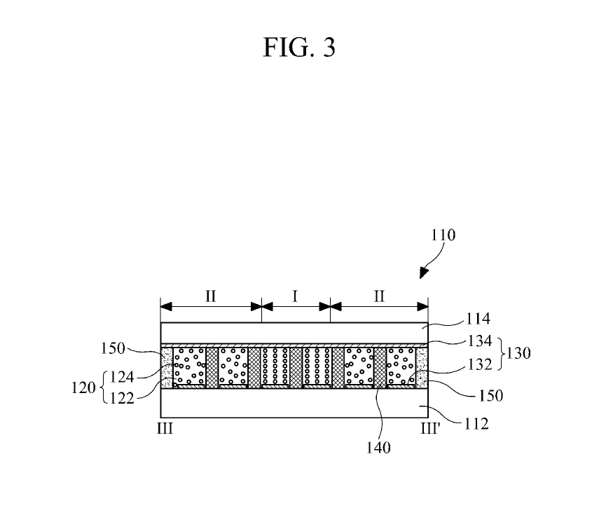

FIG. 1 is a diagram illustrating a touch panel 10 according to an embodiment, FIG. 2 is an exploded perspective view illustrating a touch panel body of the touch panel 10 illustrated in FIG. 1 according to an embodiment, and FIG. 3 is a cross-sectional view cut along a line III-III′ of FIG. 2.

Referring to FIG. 1, the touch panel 10 includes a touch panel body 100, a determining unit 102, and a controller 104. The touch panel body 100 includes a physical structure configuring the touch panel 10, and a power unit. The determining unit 102 and controller 104 may be electrical circuits and/or hardware/software which senses an input to the touch panel body 100 and determines the type of the input to thus controls driving of the touch panel body 100. In the following description, the term “touch panel” indicates the touch panel body 100 in the narrow sense of the term, but in the broad sense of the term, may indicate the entire touch panel 10 including the determining unit 102 and controller 104.

In this description, the determining unit 102 and controller 104 are only logically classified according to their functions and accordingly may be physically incorporated or separated. The logical functional classification of the determining unit 102 and the controller 104 is only for convenience of description, and one or both of the determining unit 102 and the controller 104 may perform all functions of the determining unit 102 and the controller 104 or functions performed by any one of the determining unit 102 and the controller 104 may be also performed by the other one. Hereinafter, the structure of the touch panel 10 will be described with reference to FIGS. 2 and 3.

Referring to FIGS. 2 and 3, the touch panel body 100 includes a pair of substrates (that is, a lower substrate 112 and a upper substrate 114), electro-rheological fluid 120, a plurality of driving electrode pairs 130, a plurality of spacers 140, and sealant 150.

The lower substrate 112, which is a base substrate of the touch panel body 100, acts as one side of a container for filling the electro-rheological fluid 120 in the touch panel body 100. When the touch panel 10 is used as a touch screen of an electronic device, the lower substrate 112 may act as a display of the electronic device or as a substrate that is additionally attached to the display. The lower substrate 112 is not deformed when a certain attractive force or repulsive force is applied between the lower substrate 112 and the upper substrate 114. For prevention of deformation, the lower substrate 112 may be made of a hard substance, and for example, the lower substrate 110 may be a glass substrate made of transparent glass. However, there may be cases where the lower substrate 112 is made of any other material that is not a hard substance. For example, when the touch panel body 100 is attached onto a hard display, the lower substrate 110 may be made of a transparent polymer film.

The front surface of the upper substrate 114 is a user touch surface (S) which the user contacts to generate an input signal. The upper substrate 114 may be deformed when a certain force is applied thereon. For example, when a user contacts or presses the user touch surface S with his or her finger, a stylus pen or the like, the upper substrate 114 may be deformed. For such deformation to occur, the upper substrate 114 may be made of a transparent, deformable polymer film or the like. Also, the upper substrate 114 may be separated by a predetermined distance from the lower substrate 112, so that a gap is formed between the upper substrate 114 and the lower substrate 112.

The electro-rheological fluid 120 fills the gap between the lower substrate 112 and the upper substrate 114. The electro-rheological fluid 120 is a suspension where very fine particles 124 are dispersed in electro-insulative fluid 122. The electro-rheological fluid 120 may be transparent liquid or opaque liquid according to the type of an application. The viscosity of the electro-rheological fluid 120 varies maximally by 100,000 times when an electric field is applied thereto, and since such variation in viscosity is reversible, the viscosity returns to its original level when the electronic field disappears.

The electro-insulative fluid 122 in the electro-rheological fluid 120 may be Silicon oil, Kerosene mineral oil, PCBs, and the like. However, the electro-insulative fluid 122 may be any other material whose viscosity changes little according to changes in temperature and which has the characteristic of a high flash point and a low freezing point. The particles 124 included in the electro-rheological fluid 120 may be very fine, transparent particles having a size of maximally about 50 μm . The particles 124 may have a size of several microns. The particles 124 may be polymers, such as aluminosilicate, polyaniline or polypyrrole, fullerene, etc., or insulative materials such as ceramic. As mentioned above, the electro-rheological fluid 120 may be an opaque material according to the type of application.

The electro-rheological fluid 120 may be sealed between the lower and upper substrates 112 and 114, and for sealing the electro-rheological fluid 120, a sealant 150 may be applied onto the facing edge portions of the lower and upper substrates 112 and 114. As illustrated in FIGS. 2 and 3, the sealant 150 may be formed as a sealing dam whose height corresponds to the thickness of the gap between the lower and upper substrates 112 and 114, however, this is only exemplary. The sealant 150 may be made of a material, such as silicon, modified silicon, polysulfide, polyurethane, or the like, which is used to seal up fluid in an electronic device (for example, a liquid display panel). Also, the sealant 150 may be made of the same or different material as the spacers 140.

The spacers 140 may be placed in a dispersed manner in the gap between the lower and upper substrates 112 and 114. The spacers 140 may be dispersed at regular intervals or randomly over the entire region of the touch panel body 100. The spacers 140 may be made of elastomers having elasticity, such as silicon rubber and the like, but may be made of any other material. The spacers 140 may be, as mentioned above, made of the same material as the sealant 150. The spacers 140 may be pillar-shaped structures having the same height as the sealant 150 or a lower height than the sealant 150, which will be described later. The height of the spacers 140 may be dozens or hundreds of micrometers.

The spacers 140 may provide a restoring force to the upper substrate 114 that has been pressed and deformed. In this case, the spacers 140 act as elastic members between the lower and upper substrates 112 and 114, and cause the deformed upper substrate 114 to be flattened. The spacers 140 also may act to support the upper substrate 114 structurally, and in this case, the height of the spacers 140 may be the same as that of the sealant 150, that is, as the gap thickness between the lower and upper substrates 112 and 114. The upper substrate 114 may be supported by tension of the film or by pressure caused by the electro-rheological fluid 120, although not supported by the spacers 140.

As described above, the spacers 140 do not need to be dispersed over the entire region of the touch panel body 100. That is, the spacers 140 may be placed in any arbitrary distribution pattern as long as they provide a structural support function. For example, since the touch panel has higher film tension in its edge portions rather than in its center portion, more spacers 140 may be distributed in the edge portions of the touch panel than in the center portion. That is, the spacers 140 may be distributed with different densities on the touch panel body 100. However, the spacers 140 may be distributed randomly over the entire region of the touch panel body 100.

The driving electrode pairs 130 are formed by arranging electrodes formed on the lower substrate 112 in pairs with electrodes formed on the upper substrate 114. In more detail, each driving electrode pair 130 is a pair of lower and upper electrodes that are formed respectively on the lower and upper substrates 112 and 114 and face each other. The lower and upper electrodes do not need to be made of a transparent material, and may be made of a metal material, such as Cu and the like, generally used for electrical wirings.

The driving electrode pairs 130 may be arranged in an array form or in a matrix form over an entire region of the touch panel body 100. The array of the driving electrode pairs 130 is a group of driving electrode pairs 130 that are defined by a plurality of lower electrode patterns formed on the lower substrate 112 and a plurality of upper electrode patterns formed on the upper substrate 114. FIG. 2 shows an example of driving electrode pairs 130 arranged in an array form. Referring to FIG. 2, a plurality of lower electrode lines 132 and a plurality of upper electrode lines 134 are respectively formed on the upper surface of the lower substrate 112 and on the lower surface of the upper substrate 114. Here, the plurality of lower electrode lines 132 extend parallel in a first direction, and the plurality of upper electrode lines 134 extend parallel in a second direction. The array of the driving electrode pairs 130 are defined at intersections of the plurality of lower electrode lines 132 and the plurality of upper electrode lines 134.

Unlike this, lower and upper electrode patterns, each having a dot shape, may be arranged in a matrix form on the entire regions of the lower and upper substrates, respectively.

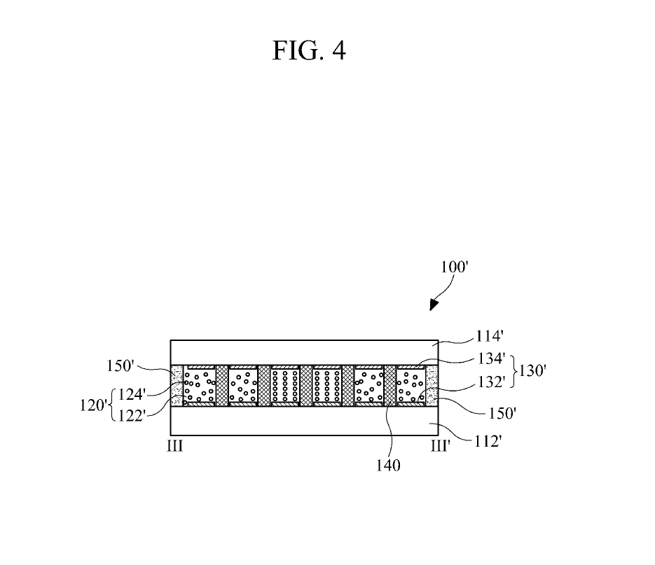

FIG. 4 is a cross-sectional view illustrating another exemplary embodiments of a touch panel body 100′ including dot-shaped lower and upper electrodes. Referring to FIG. 4, the touch panel body 100′ includes a plurality of lower electrodes 132′ formed on the lower substrate 112′ and a plurality of upper electrodes 134′ formed on the upper substrate 114′. The arrangement of the lower and upper electrodes 132′ and 134′ may correspond to the case where an M×N electrode array is formed on each of the lower and upper substrates 112′ and 114′. Also, the individual driving electrode pairs 130′ may be independently addressed and controlled.

Referring again to FIG. 2, the touch panel body 100, and more particularly the driving electrode pairs 130 are connected to a power unit 160. The power unit 160 may include a power supply of an electronic device on which the touch panel 10 (see FIG. 1) is mounted. The power unit 160 includes a source power supply that generates a driving voltage that is to be applied to the driving electrode pairs 130 and/or a sensing voltage. The driving voltage generated by the source power supply is applied to the driving electrode pairs 130. The driving voltage applied to the driving electrode pairs 130 generates a driving force (that is, an electric field) that changes the viscosity of the electro-rheological fluid 120. Also, the sensing voltage generated by the source power supply is applied to the driving electrode pairs 130 to determine whether or not an input occurs and where an input occurs. For example, U.S. application Ser. No. 12/948,479, entitled “Touch Panel and Electronic Device Including the Same”, filed on Nov. 17, 2010 by the same applicant discloses an example of a driving and sensing algorithm for a touch panel using electro-rheological fluid. The entire disclosure of U.S. application Ser. No. 12/948,479 is incorporated herein by reference for all purposes.

The driving voltage may be applied to a predetermined combination of the driving electrode pairs 130, that is, to a part of the driving electrode pairs 130. FIG. 3 corresponds to the case where the driving voltage is applied only to driving electrode pairs in a region I and no driving voltage is applied to driving electrode pairs in regions II. For this, it is possible that while a predetermined magnitude of voltage is applied to the upper electrode lines 134, the lower electrode lines in the region I are grounded and the lower electrode lines in the region II are kept in a floating state. However, it is also possible that while a predetermined magnitude of voltage is applied to the lower electrode lines 132, the upper electrode lines 134 in the region I are grounded and the upper electrode lines 134 in the regions II are in a floating state.

When a driving voltage is applied to the driving electrode pairs in the region I of FIG. 3 (for example, when a predetermined voltage is applied to upper electrode lines 134 in the region I and the lower electrode lines 132 are grounded), an electric field is locally formed between the upper and lower substrates 112 and 114 on which the corresponding driving electrode pairs 130 are arranged. Accordingly, due to the electric field, the viscosity of the electro-rheological fluid 120 belonging to the region I increases. The reason why the viscosity of the electro-rheological field 120 increases due to an electric field is because particles 124 having polarization behavior are aligned along the orientation of the electric field, which is illustrated in FIG. 3. Meanwhile, when no driving voltage is applied to the driving electrode pairs 130 in the regions II (for example, when a predetermined voltage is applied to the upper electrode lines 134 and the lower electrode lines 132 remain in a floating state), no electric field is formed between the lower and upper substrates 112 and 114 on which the corresponding driving electrode pairs 130 are arranged, so that the viscosity of the electro-rheological fluid 120 belonging to the regions II does not change.

An example of a touch panel using changes in viscosity of electro-rheological fluid is disclosed in detail in U.S. application Ser. No. 12/780,966, entitled “Touch Panel and Electronic Device Including the Same”, filed on May 17, 2010 by the same applicant. U.S. application Ser. No. 12/780,966 discloses a touch panel in which changes in viscosity of electro-rheological fluid are used to define predetermined input button areas on a user touch surface and provide users with a clicking sensation like when pressing a mechanical keypad. The entire disclosure of U.S. application Ser. No. 12/780,966 is incorporated herein by reference for all purposes.

The clicking sensation is a sense of “clicking” which is felt by a finger when pressing a mechanical keypad or a key button of a mobile phone or the like. In a mechanical keypad, a thin metal plate having a dome shape, which is called a metal dome, is installed below a key button. When the metal dome is pressed, the user may first sense a repulsive force due to deformation. If the deformation exceeds predetermined criteria, there is a buckling point causing sharp deformation. Due to such a buckling point, the user can sense or feel the clicking sensation.

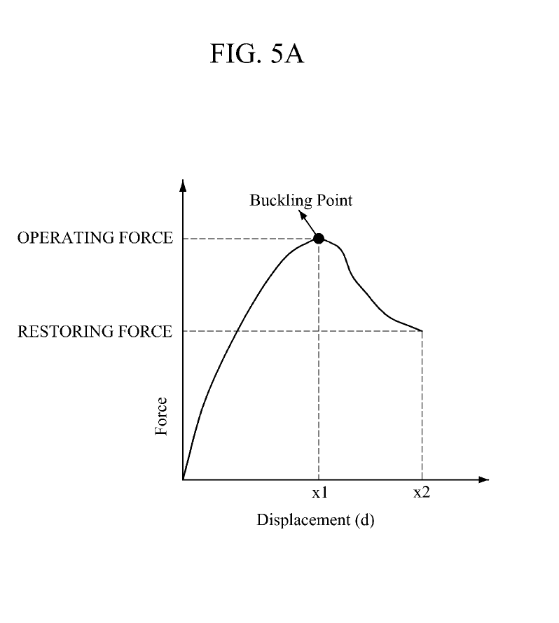

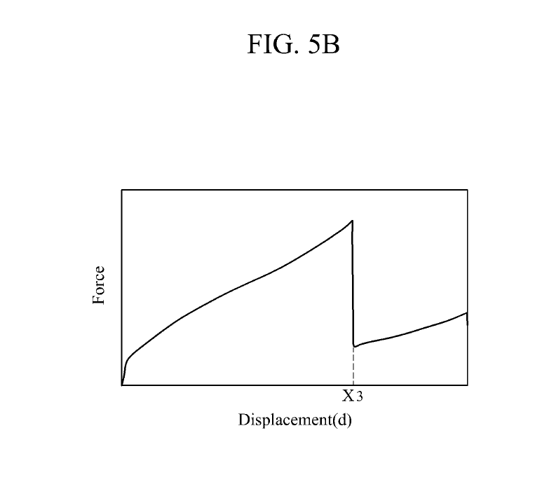

FIG. 5A is a graph showing the relationship between force and displacement when a mechanical key button having such a metal dome structure is utilized. Referring to FIG. 5A, at the initial stage, the displacement of the metal dome increases as a user's pressing force increases. Along with the increase of the user's pressing force, the supporting force (a resistive force against deformation) of the metal dome increases and accordingly a repulsive force from the button is felt by the user. Furthermore, the supporting force of the metal dome continues to increase until the user's pressing force reaches a predetermined criteria (an operating force), and when the displacement of the metal dome reaches x 1 , a buckling point is reached at which the supporting force of the metal dome sharply decreases. If the user's pressing force is maintained even after the bucking point, the displacement of the metal dome continues to increase, and when the displacement of the metal dome reaches x2, the metal dome reaches the lower electrodes. Thereafter, if the user's pressing force disappears, the metal dome returns to its original state by a restoring force.

The touch panel 10 (see FIG. 1) allows users to experience a clicking sensation by imitating a mechanism of a mechanical key button. FIG. 5B is a graph showing a relationship between the displacement of the upper substrate and a force (a repulsive force) applied to a region (for example, the region I of FIG. 3) to which a driving voltage is supplied, in a touch panel (for example, the touch panel 10 of FIG. 1) including electro-rheological fluid. Referring to FIG. 5B, as the displacement of the upper substrate increases, the repulsive force increases accordingly. Thereafter, when the displacement reaches a predetermined value (that is, X3), the driving voltage disappears, which sharply reduces the repulsive force of the touch panel 10, wherein the repulsive force at the displacement X3 corresponds to an activation force value of the touch panel 10. The sharp reduction of the repulsive force is caused by a sharp reduction in viscosity of electro-rheological fluid due to the disappearance of the electric field. This way, the touch panel 10 may , when the driving voltage disappears, allow a user to sense the same clicking sensation felt at a buckling point when pressing a mechanical key button.

Referring again to FIG. 1, the determining unit 102 determines the type of input by sensing a user's contact or pressing operation. In more detail, the determining unit 102 determines whether a user's current input is a click input or a continuous input. For example, the determining unit 102 may determine the type of input depending on whether the location of the input changes over time. The determining unit 102 may determine the input as a “continuous input” when the input location continues to change for a predetermined time and the travel distance of the input location is equal to or longer than a predetermined distance (a threshold value), and as a “click input” when the input location does not change for the predetermined time or the travel distance of the input location is shorter than the predetermined distance (the threshold value). Here, setting a threshold value in association with a travel distance of an input location takes into consideration that the input location of even a click input may change a little when the input occurs using fingers having relatively wide contact areas.

When determining the type of input, the determining unit 102 may consider only whether a user contacts or presses the user touch surface of the upper substrate 114, not considering a degree of the contact or pressing, for example, whether a force applied to the user touch surface exceeds the activation force value. At this time, the touch panel 10 may determine whether the user touch surface is pressed by sensing a change of the gap thickness between the lower and upper substrates 112 and 114. The change of the gap thickness between the lower and upper substrates 112 and 114 may be sensed by detecting a change in capacitance due to a change of the gap thickness between the driving electrode pairs 130.

Then, the determining unit 102 determines whether the current input occurs with a force exceeding an activation force value according to a predetermined input type, that is, whether the current input can be considered as an input. In more detail, the determining unit 102 may set different activation force values according to predetermined input types, and determine whether a force exceeding an activation force value corresponding to the current input is applied to the user touch surface. For example, if the input type of the current input is determined to be a click input, the determining unit 102 may set the activation force value to a relatively great value, whereas if the input type is determined to be a continuous input, the determining unit 102 may set the activation force value to a relatively small value. Activation force values that are applied in association with the click input and continuous input may be set according to the type of a touch panel or by a user. The activation force values are amounts of force applied by a user required to indicate the type of input.

As such, by setting a relatively great activation force value in association with a click input, it is possible to prevent input errors due to proximity sensing. The reason is because since a contact or pressing operation onto the peripheral area of an input location occurs with a relatively small force, the greater activation force value for the click input causes the higher possibility that the determining unit 102 will not consider the contact or pressing operation onto the peripheral area as an input. Also, by setting a relatively low activation force value in association with a continuous input, it is possible to provide a user with a soft sense of touch since the determining unit 102 will consider a contact or pressing operation with a relatively small force as an input. That is, the smaller the activation force value, the softer the sense of touch offered to a user.

According to an embodiment, the determining unit 102 sets different activation force values according to predetermined input types to determine whether or not an input occurs, however, this is only exemplary. For example, the determining unit 102 may differentiate activation force values in consideration of the types and/or processing stages of applications that are executable in an electronic device. The activation force values also may be set according to the type of a touch panel or by a user. For example, a user who prefers a soft sense of touch may set the activation force value to relatively small values, and the determining unit 102 may determine whether or not an input occurs based on the set activation force values.

The controller 104 controls releasing of the driving voltage applied to the driving electrode pairs 130, based on the results of the determination received from the determining unit 102. In more detail, if the determining unit 102 determines that a current input contacts or presses the user touch surface with a force exceeding an activation force value, the controller 104 may control the touch panel 10, particularly, the power unit 160 (see FIG. 2) of the touch panel 10 to release a driving voltage applied to driving electrode pairs 130 corresponding to at least the location where the current input occurs. Then, the user will get a clicking sensation when the driving voltage disappears, which has been described above. Also, the controller 104 may maintain the applied driving voltage in the other area except the current input location or release the applied driving voltage from a part of the other area. According to another embodiment, the controller 104 may release the applied driving voltage from all the driving electrode pairs 130 to which the driving voltage has been applied.

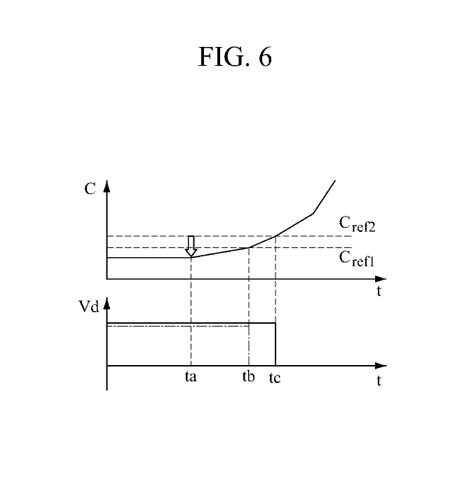

FIG. 6 is a graph showing timings at which the determining unit 102 of the touch panel 10 illustrated in FIG. 1 determines an input type and whether or not an input occurs and the controller 104 releases a driving voltage. The graph illustrated in FIG. 6 relates to the touch panel 10 which determines whether an input occurs based on a change in capacitance between driving electrode pairs. The determining unit 102 of the touch panel 10 detects an input location where driving electrode pairs from which a change in capacitance is sensed. In this case, the determining unit 102 applies a predetermined capacitance reference value corresponding to the determined input type to determine whether or not an input occurs. In FIG. 6, t_{c} is shown to occur after t_{b}, however, this is only exemplary. Since the touch panel 10 determines whether an input occurs only based on any one of a continuous input and a click input, t_{c} and t_{b} are substantially independent values.

Referring to FIGS. 1 and 6, when the upper substrate of the touch panel 10 starts to be pressed at a predetermined time tₐ, the pressed area is recessed so that the gap thickness between driving electrode pairs in the pressed area is reduced. In the pressed area, capacitance between the driving electrode pairs increases, and the determining unit 102 may determine whether the current input is a click input or a continuous input based on the increase in capacitance. At this time, if the measured value of the capacitance is smaller than a predetermined threshold value (the predetermined threshold value is set to C_{ref1} in association with a continuous input and to C_{ref2} in association with a click input, and a method of sensing the predetermined threshold values C_{ref1} and C_{ref2} will be described later), the determining unit 102 determines that no input occurs. In this case, if a user continues to press the same location (in the case of the click input) or presses the peripheral area of the input location with a greater force (in the case of the continuous input), displacement of the upper substrate increases so that capacitance between the driving electrode pairs at the current input location continues to increase. Thereafter, when the displacement of the upper substrate reaches a predetermined distance so that the capacitance at the corresponding driving electrode pairs reaches a predetermined threshold value, the determining unit 102 determines that a user input occurs at that time t_{b} or t_{c}, so that the controller 104 controls the power unit (160 of FIG. 2) to release the driving voltage.

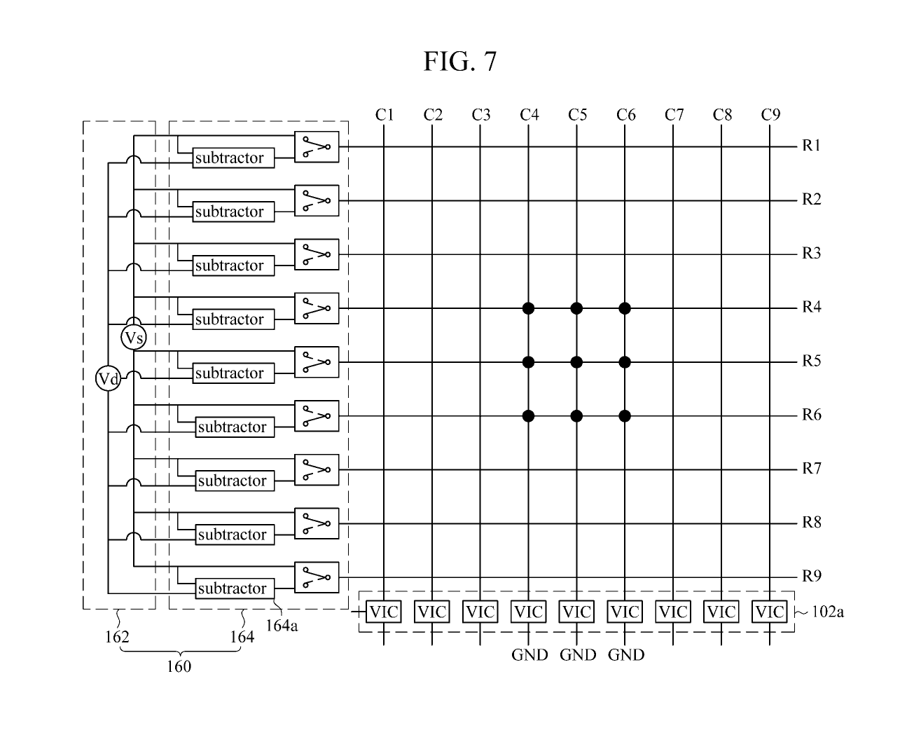

FIG. 7 illustrates an example of a circuit structure for the touch panel 10 illustrated in FIG. 1. The circuit structure corresponds to a part (for example, 9 lower electrode lines 132 and 9 upper electrode lines 134) of driving electrodes 130 of the touch panel body 100 illustrated in FIG. 2. Here, the lower and upper electrode lines 132 and 134 of the touch panel body 100 respectively correspond to the row and column electrode lines R1 through R9 and C1 through C9 illustrated in FIG. 5 or vice versa. The example illustrated in FIG. 7 shows the case where only driving electrodes (intersections of R4 through R6 and C4 through C6) denoted by dots among driving electrodes (intersections of the row and column electrode lines R1 through R9 and C1 through C9) are driving cells (accordingly, a driving area includes 9 dots), however, this is only exemplary.

Referring to FIG. 7, the circuit structure for the touch panel 10 includes a pulse generating circuit unit 162, a pulse applying circuit unit 164, and a sensing circuit unit 102a. The touch panel 10 may further include elements (not shown) for controlling the pulse generating circuit unit 162, the pulse applying circuit unit 164, and the sensing circuit unit 102a. Detailed configurations of the pulse generating circuit unit 162, the pulse applying circuit unit 164, and the sensing circuit unit 102a illustrated in FIG. 7 are different from the configurations of the touch panel 10 illustrated in FIGS. 1 and 2, but these are only differences in the point of view. For example, the pulse generating circuit unit 162 and pulse applying circuit unit 164 illustrated in FIG. 7 may be components included in the power unit 160 illustrated in FIG. 2. Also, the sensing circuit unit 102a may be a component included in the determining unit 102 illustrated in FIG. 1, and the controller 104 illustrated in FIG. 1 may include elements for controlling the pulse generating circuit unit 162, the pulse applying circuit unit 164, and the sensing circuit unit 102a.

The pulse generating circuit unit 162 generates a driving pulse voltage Vd and a sensing pulse voltage Vs and applies them to the pulse applying circuit unit 164. The driving pulse voltage Vd is an example of a driving signal for driving electro-rheological fluid, and the sensing pulse voltage Vs is an example of a sensing signal for detecting an input from a user. The driving pulse voltage Vd has a high voltage of several dozens of volts (for example, about 100V) to drive electro-rheological fluid, and the sensing pulse voltage Vs may have a low voltage of several volts required for sensing by the sensing circuit unit 102a. The voltage values of the driving pulse voltage Vd and sensing pulse voltage Vs depend on the physical structure (for example, the gap thickness of the substrates, the electrical characteristics of electro-rheological fluid, and/or the cross section of each driving electrode, etc.) of the touch panel body 100 (see FIG. 2) or the type or electrical characteristics of a sensing circuit used in the sensing circuit unit 102a, which has been described above.

Also, the driving pulse voltage Vd may be maintained for a relatively long time period (for example, 1 second or more). The maintenance time period of the driving pulse voltage Vd may be a predetermined value set by the touch panel 10 or an arbitrary value set by a user. Meanwhile, the sensing pulse voltage Vs may be maintained only for a very short time period, for example, for one hundredth or thousandth seconds or for several microseconds. The shorter the maintenance time period of the sensing pulse voltage Vs, the shorter a sensing time period per which the entire surface of the touch panel 10 is sensed.

The pulse generating circuit unit 162 generates the driving pulse voltage Vd and may apply the driving pulse voltage Vd to 3 row electrode lines R4, R5 and R6 connected to 9 driving cells. In this case, the driving pulse voltage Vd may be simultaneously applied to the 3 row electrode lines R4, R5 and R6. Then, the pulse generating circuit unit 162 may generate a sensing pulse voltage Vs and transfer the sensing pulse voltage Vs to the pulse applying circuit unit 164 to apply the sensing pulse voltage Vs to all or a part of the row electrode lines R1 through R9. In this case, the sensing pulse voltage Vs may be sequentially applied to the row electrode lines R1 through R9.

The sensing pulse voltage Vs may be sequentially applied to the row electrode lines R1 to R3 and R7 to R9 connected to no driving cells, as well as to the row electrode lines R4, R5 and R6 connected to the driving cells. Accordingly, it is possible to sense changes in capacitance even from driving electrode pairs to which no driving voltage Vd is applied. As such, by sequentially applying a sensing signal to all the row electrode lines R1 through R9 to perform scanning, non-driving areas (for example, the regions II of FIG. 3) as well as driving areas (for example, the region I of FIG. 3) may be sensed, which implements multi-touch recognition.

The pulse applying circuit unit 164 may integrate the driving pulse voltage Vd with the sensing pulse voltage Vs, which are received from the pulse generating circuit unit 162, and applies the integrated voltage to the row electrode lines R1 through R9. For the voltage integration, the pulse applying circuit unit 164 may include a pulse integration circuit for integrating the driving pulse voltage with the sensing pulse voltage for each of the row electrode lines R1 through R9. The pulse integration circuit may be a subtractor 164a. Also, the pulse applying circuit unit 164 may select one of the integrated pulse voltage received from the pulse integration circuit (for example, the subtractor 164a) and the sensing pulse voltage received from the subtractor 164a, and apply the selected voltage to the row electrode lines R1 through R9. For this, the pulse applying circuit unit 164 may include a switching device for selecting one pulse voltage from two input pulse voltages.

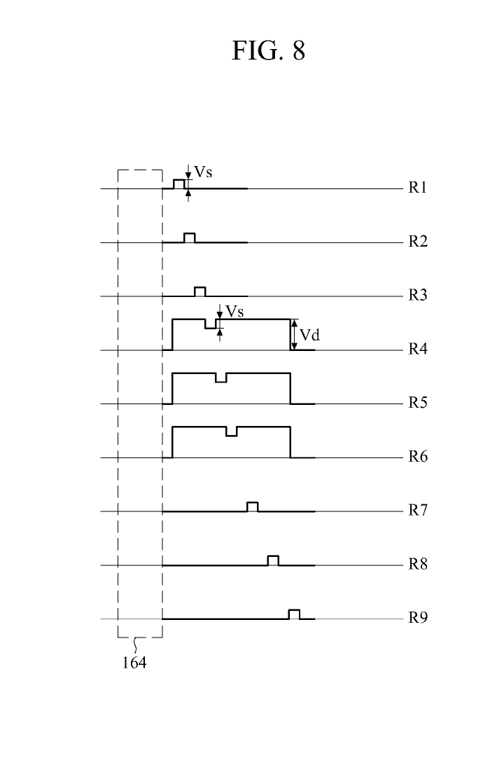

FIG. 8 illustrates an example of a timing chart of the driving voltage Vd and the sensing pulse voltage Vs that are applied to the row electrode lines R1 through R9 illustrated in FIG. 7. FIG. 8 shows the case where 3 row electrode lines R4, R5 and R6 of the row electrode lines R1 through R9 are connected to driving cells. The magnitudes, maintenance time periods, etc. of the driving pulse voltage Vd and sensing pulse voltage Vs are only exemplary. Referring to FIG. 8, a driving pulse voltage Vd (in more detail, a driving pulse voltage Vd from which a sensing pulse voltage is subtracted) as a driving signal is applied to the 3 row electrode lines R4, R5 and R6 connected to the driving cells. The sensing pulse voltage Vs which is a sensing signal is sequentially applied to all the row electrode lines R1 through R9, or the sensing pulse voltage Vs is integrated with the driving pulse voltage Vd and then sequentially applied to all the row electrode lines R1 through R9.

Referring again to FIG. 7, the sensing circuit unit 102a determines whether there is any input to the intersections (driving electrode pairs) of the row electrode lines R1 through R9 and the column electrode lines C1 through C9, in response to the sensing signals (the sensing pulse voltages Vs) that are sequentially input to the row electrode lines R1 through R9. As described above, the sensing circuit unit 102a measures capacitance at each driving electrode pair and compares the measured capacitance to a predetermined reference capacitance according to an input type, thereby determining whether there is any input to the driving electrode pairs.

A method in which the sensing circuit unit 102a measures capacitance and compares the measured capacitance to a certain reference value is not limited. For example, the sensing circuit unit 102a compares electrical signals (for example, voltages or current) output from the column electrode lines C1 through C9 to a predetermined reference value (a reference voltage or current corresponding to a reference capacitance value) to determine whether there is any input to the driving electrode pairs. For the determination, the sensing circuit unit 102a may include voltage-to-current converters (VICs) and comparators, which are one-by-one connected to the column electrode lines C1 through C9. However, the configuration of the sensing circuit unit 102a may not be limited to this, and for example, charge amplifiers instead of voltage-to-current converters may be used.

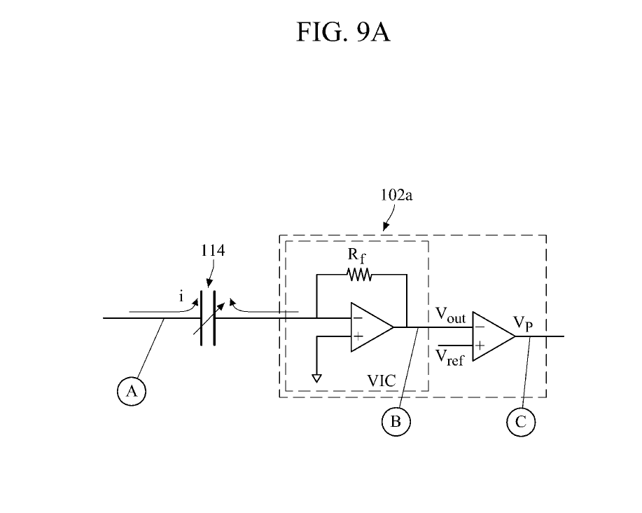

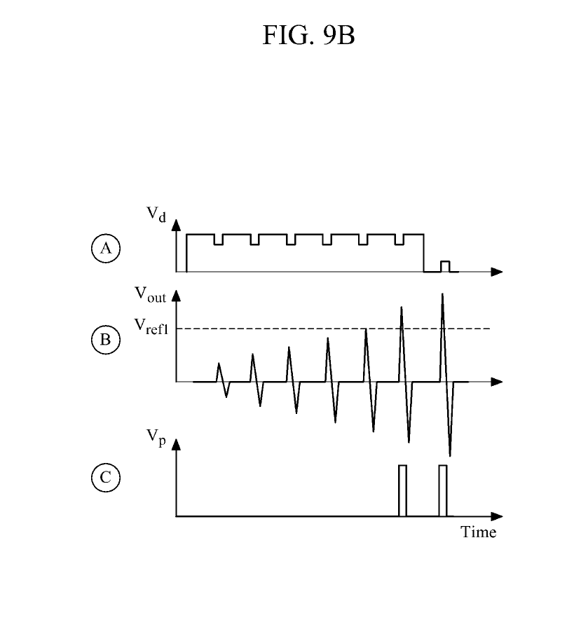

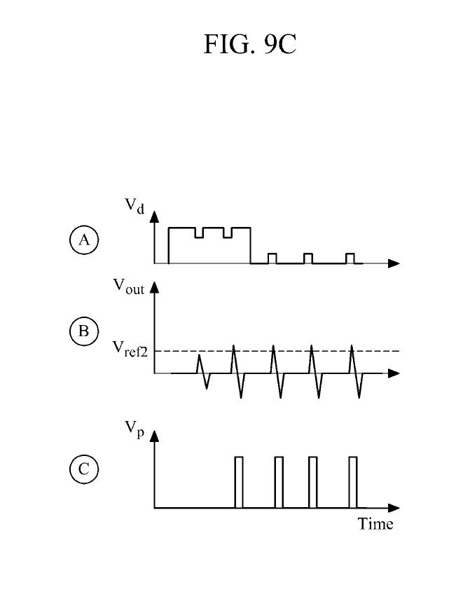

FIG. 9A is a circuit diagram of a circuit including a VIC and a comparator, which is an example of the sensing circuit unit 102a illustrated in FIG. 7. Referring to FIG. 9A, when capacitance of a driving electrode pair changes due to a change in the gap thickness between lower and upper substrates of a touch panel, the amount of charges (that is , current i) charged to and discharged from both terminals of the capacitor (that is, the driving electrode pair) by an input pulse voltage also changes. The change of the current i passes through the VIC, thereby appearing as a change of an output voltage Vₒᵤₜ corresponding to a product of feedback resistance R_{f} and the current i. Then, the comparator compares the output voltage Vₒᵤₜ to a reference voltage V_{ref} to determine whether there is any input to the driving electrode pair. The reference voltage V_{ref} is a predetermined value that is set depending on whether the type of input is a click input or a continuous input.

FIGS. 9B and 9C are timing charts showing input and output voltages at terminals \textcircled{a}, \textcircled{b} and \textcircled{c} of the circuit illustrated in FIG. 9A, wherein FIG. 9B corresponds to the case where the type of input is a click input and FIG. 9C corresponds to the case where the type of input is a continuous input. Referring to FIG. 9B, when the output voltage Vₒᵤₜ at the terminal \textcircled{b} is higher than a reference voltage V_{ref1} of a click input, a pulse signal Vₚ indicating that an input occurs is sensed at the terminal \textcircled{c}. Then, a driving voltage pulse is no longer applied to the terminal \textcircled{a} and only a sensing voltage pulse is applied to the terminal \textcircled{a}. Likewise, referring to FIG. 9C, when the output voltage Vₒᵤₜ at the terminal \textcircled{b} is higher than a reference voltage V_{ref2} of a continuous input, a pulse signal Vₚ indicating that an input occurs is sensed at the terminal \textcircled{c}. Then, a driving voltage pulse is no longer applied to the terminal \textcircled{a} and only a sensing voltage pulse is applied to the terminal \textcircled{a}.

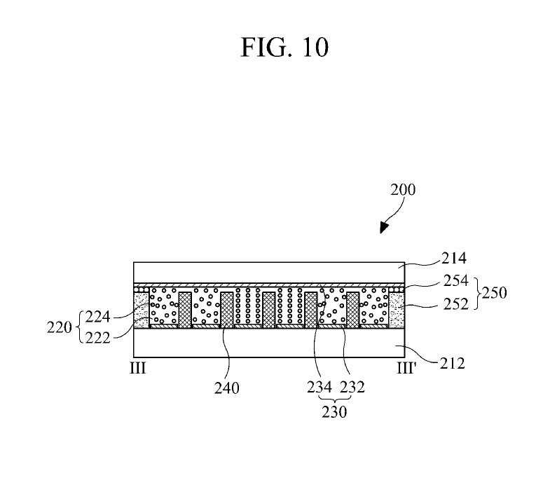

FIG. 10 is a cross-sectional view illustrating another embodiment of a touch panel body 200. The configuration of a touch panel including the touch panel body 200 may be the same as the configuration of the touch panel 10 illustrated in FIG. 1. In order to avoid repeated descriptions, the touch panel body 200 will be described based on differences between the touch panel body 200 and the touch panel body 100 illustrated in FIG. 2.

Referring to FIG. 10, the touch panel body 200 includes, like the touch panel body 100, a pair of substrates (that is, a lower substrate 212 and a upper substrate 214), electro-rheological fluid 220, driving electrode pairs 230, spacers 240, and sealant 250. However, the touch panel body 200 according to the current exemplary embodiment is different from the touch panel body illustrated in FIG. 2 in that the spacers 240 do not act to support the upper substrate 214.

In more detail, the spacers 240 do not contact the upper substrate 214 and are spaced a predetermined distance apart from the upper substrate 214. For this structure, the spacers 240 may be structures having a height lower than that of the sealant 250. For example, the sealant 250 may be formed as a duplicated structure including a sealing dam 252 having the same height as the spacers 240 and a separation member 254 that is mounted on the sealing dam 252 and contacts the upper substrate 214. In this case, the separation member 254 is not necessarily made of the same material as the sealing dam 252. For example, the separation member 254 may be a sealing ball that is used to manufacture an LCD. As such, in the case where the sealant 250 is formed as a duplicated structure, the sealing dams 252 and the spacers 240 having the same height may be formed at once, which makes a manufacturing process efficient. However, it is also possible that the sealant 250 may be formed as a single structure, for example, as a sealing dam having a height higher than the spacers 240.

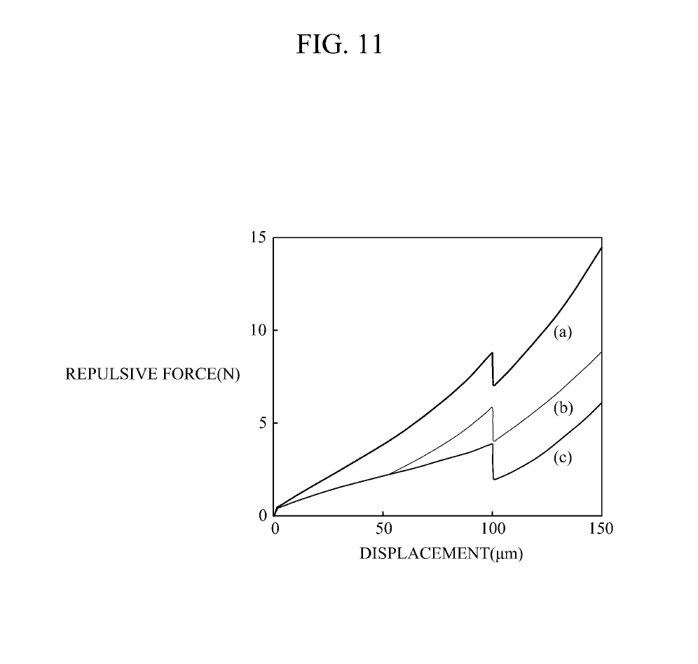

FIG. 11 is a graph showing changes in repulsive force with respect to displacement of upper substrates in touch panels with different gap thicknesses between the upper substrates and spacers. (a), (b) and (c) in the graph respectively correspond to the cases where the gap thicknesses between the upper substrates and the spacers are 0 μm, 50 μm and 10 μm, respectively. In a touch panel, the distance between the upper and lower substrates is 200 μm, and a driving voltage is released when displacement of the upper substrate reaches 100 μm. Referring to FIG. 11, in the case where no gap between the upper substrate and spacers exists ((a) of the graph), a strong repulsive force is generated from when displacement starts to be made, whereas in the case where a gap between the upper substrate and spacers exists ((b) and (c) of the graph), a relatively small repulsive force is generated. Also, when the same displacement is made, the case where a gap between the upper substrate and spacers exists ((b) and (c) of the graph) makes the smaller repulsive force than the case where no gap between the upper substrate and spacers exists ((a) of the graph). The reason for such is that in the touch panel body 200 illustrated in FIG. 10, a repulsive force is generated only by the electro-rheological fluid 220 until the deformed upper substrate 214 contacts the spacers 240.

As such, in the touch panel body 200 in which the spacers 240 do not support the upper substrate 210 and are spaced a predetermined distance apart from the upper substrate 210, a repulsive force felt by a user when the upper substrate 2134 is deformed by a contact or pressing operation onto a user touch surface is smaller than in the touch panel body 100 illustrated in FIG. 2. In the distance range by which the spacers 240 are spaced apart from the upper substrate 214, a repulsive force is generated only by the electro-rheological fluid 220 and accordingly the repulsive force is very small. Accordingly, in the distance range by which the spacers 240 are spaced apart from the upper substrate 214, the touch panel body 200 may be subject to significantly great deformation even when a small force is applied to the touch panel body 200. The touch panel including the touch panel body 200 may offer a user who does particularly a continuous input (having a lower activation force value than a click input) a softer sense of contact.

When a displacement degree of the upper substrate 214 exceeds the distance by which the spacers 240 are spaced apart from the upper substrate 214, the repulsive force of the touch panel increase although the repulsive force is smaller than that generated in the touch panel body 100 illustrated in FIG. 2. The reason for such is that the spacers 140 generate a repulsive force when the displacement degree exceeds the spaced distance between the spacers 240 and upper substrate 214. Accordingly, the touch panel including the touch panel body 200 is effective in preventing input errors due to proximity sensing when a click input (having a higher activation force value than a continuous input) occurs.

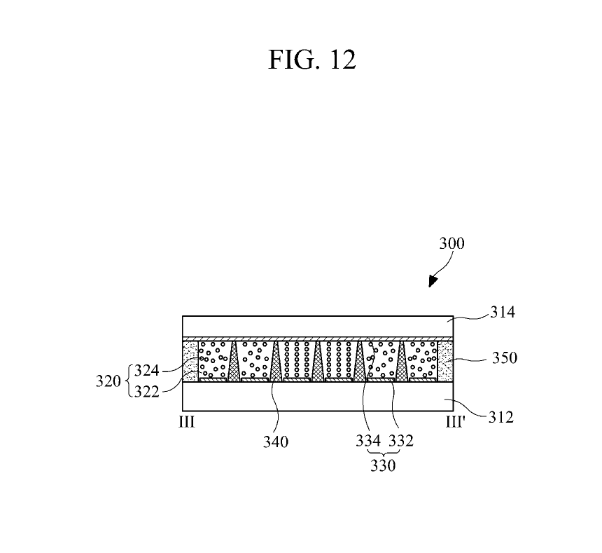

FIG. 12 is a cross-sectional view illustrating another embodiment of a touch panel body 300. The configuration of a touch panel including the touch panel body 300 illustrated in FIG. 12 may be the same as the touch panel 10 illustrated in FIG. 1. Hereinafter, the touch panel body 300 will be described based on differences between the touch panel body 300 and the touch panel body 100 illustrated in FIG. 1.

Referring to FIG. 12, the touch panel body 300 includes, like the touch panel body 100, a pair of substrates (that is, a lower substrate 312 and a upper substrate 314), electro-rheological fluid 320, driving electrode pairs 330, spacers 340, and sealant 350. However, the touch panel body 300 is different from the touch panel body 100 illustrated in FIG. 2 or the touch panel body 200 illustrated in FIG. 10 in that the spacers 340 each has a conical pillar shape whose section is reduced with an increase of height. In the embodiment of FIG. 12, like the touch panel body 100 of FIG. 1, the spacers 340 contact the upper substrate 314, however, the spacers 340 may neither contact nor support the upper substrate 314, like the touch panel 200 of FIG. 10.

In more detail, the spacers 340 may have a conical shape whose section is reduced with an increase of height. However, the spacers 340 may each have a polypyramid shape such as a triangular or quadrangular pyramid shape. Also, the section of each spacer 340 is not necessarily reduced with an increase of height and may be reduced in a convex oval shape or in a concave oval shape.

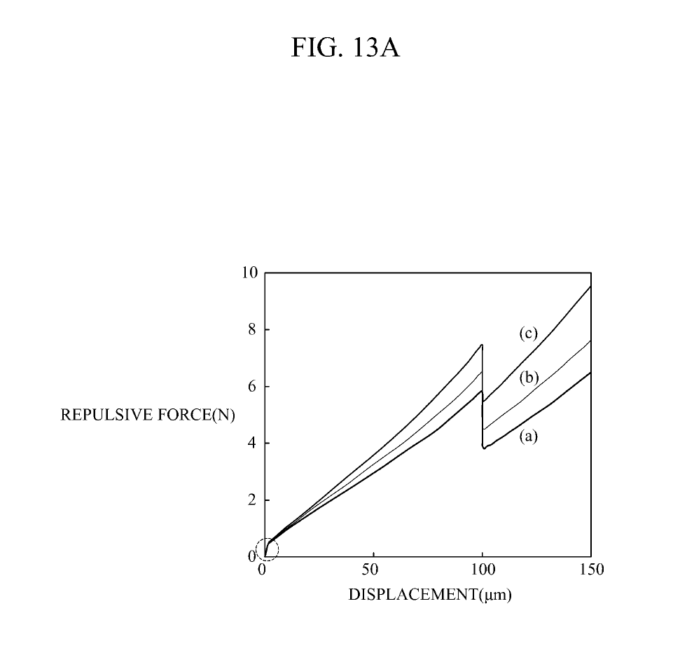

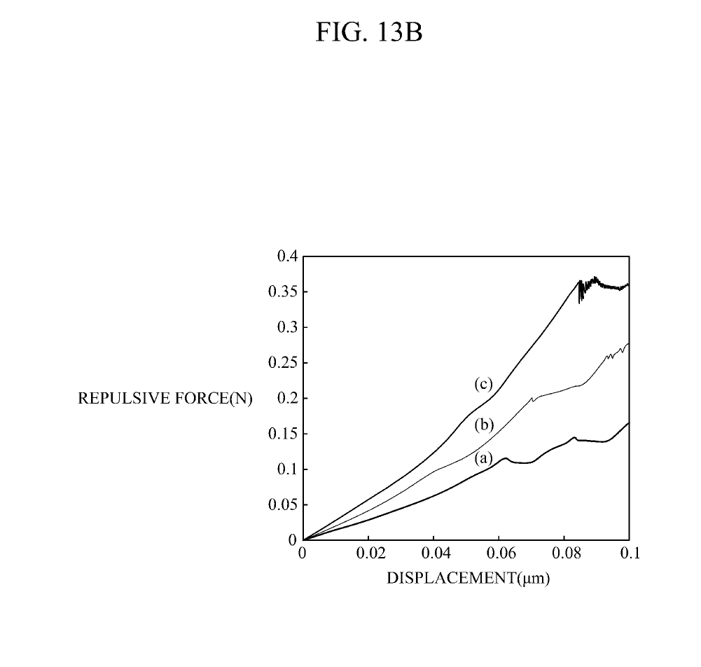

FIG. 13A is a graph showing changes in repulsive force with respect to displacement of upper substrates in touch panels with different shapes of spacers 340, and FIG. 13B is an enlarged view of a part surrounded by a dotted circle of FIG. 13A. In FIGS. 13A and 13B, (a) of the graph corresponds to the case where spacers 340 each has a pillar shape whose diameter is 100 μm, (b) of the graph corresponds to the case where spacers 340 each has a conical shape, the diameter of whose upper end section is 100 μm and the diameter of whose lower end section is 150 μm, (c) of the graph corresponds to the case where spacers 340 each has a conical shape, the diameter of whose upper end section is 150 μm and the diameter of whose lower end section is 200 μm. Referring to FIGS. 13A and 13B, when it is assumed that the sections of the upper ends of the different shapes of spacers 340 are the same, the greater the sections of the lower ends are, at the steeper angles of inclination repulsive forces with respect to displacement of the upper substrates increase. In other words, when displacement of the upper substrates are the same, the repulsive forces of the corresponding touch panels are proportional to sections of spacers at heights corresponding to the displacement of the upper substrates. Accordingly, under the same sections of the lower ends, the smaller sections of the upper ends make the repulsive forces of the corresponding touch panels smaller with respect to the same displacement of the touch panels.

As seen from FIGS. 13A and 13B, the repulsive force of the touch panel body 300 including the spacers 340 whose sections are reduced with an increase of height is smaller than that of the touch panel body 100 including spacers having a pillar shape whose upper end section is the same as the lower end section. Accordingly, by manufacturing the spacers 340 in a conical shape or in a truncated conical shape, the touch panel body 300 may obtain sufficient deformation of the upper substrate 314 with a small force. A touch panel including such a touch panel body 300 may provide a softer sense of touch to a user who performs a continuous input (having a lower activation force value than a click input) on the touch panel.

As described above, the touch panels according to the examples may offer users a clicking sensation like when pressing a mechanical keypad. Also, the touch panels may avoid input errors due to proximity sensing when a click input occurs, and offer users a soft sense of input when a continuous input occurs, by applying a relatively high activation force value in association with the click input and a relatively low activation force value in association with the continuous input.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A touch panel comprising:
a first substrate;
a second substrate spaced apart from the first substrate by a gap and having a user touch surface thereon; and
a determining unit which senses a contact or a pressing operation on the user touch surface to determine an input type, and sets an activation force value according to the input type to determine whether an input occurs.

2. The touch panel of claim 1, wherein the input type is one of a click input and a continuous input, wherein if the input type is a click input, setting the activation force value to a first value, and if the input type is a continuous input, setting the activation force value to a second value smaller than the first value.

3. The touch panel of claim 2, wherein the determining unit determines whether the input type is the click input or the continuous input, based on whether a location of the contact or the pressing operation performed onto the user touch surface changes.

4. The touch panel of claim 1, further comprising:
an array of driving electrode pairs comprising a plurality of first electrodes arranged on the first substrate and a plurality of second electrodes arranged on the second substrate, the array of driving electrodes forming an electric field in the gap between the first substrate and the second substrate when a driving voltage is applied to all or a portion of the plurality of first electrodes and the plurality of second electrodes; and
a controller which applies the driving voltage to the driving electrode pairs at a location where the input occurs, when the determining unit determines that the input occurs.

5. A touch panel comprising:
a first substrate;
a second substrate spaced apart from the first substrate by a gap and having a user touch surface thereon;
an array of driving electrode pairs comprising a plurality of first electrodes arranged on the first substrate and a plurality of second electrodes arranged on the second substrate, the array of driving electrode pairs forming an electric field in the gap between the first substrate and the second substrate when a driving voltage is applied to at least a portion of the plurality of first electrodes and the plurality of second electrodes;
electro-rheological fluid which fills the gap between the first substrate and the second substrate, a viscosity of the electro-rheological fluid increasing due to the electric field;
a sealant which is disposed on facing edge portions of the first and second substrates and seals the electro-rheological fluid;
a plurality of spacers which are disposed on the first substrate and comprise a material having elasticity; and
a determining unit which senses a contact or a pressing operation on the user touch surface to determine an input type, and which sets an activation force value according to the input type to determine whether an input occurs.

6. The touch panel of claim 5, wherein the input type is one of a click input and a continuous input, wherein if the input type is a click input, setting the activation force value to a first value, and if the input type is a continuous input, setting the activation force value to a second value smaller than the first value.

7. The touch panel of claim 5, wherein the determining unit determines whether the input type is a click input or a continuous input, based on whether a location of the contact or the pressing operation performed on the user touch surface changes.

8. The touch panel of claim 5, further comprising a controller which applies a driving voltage to the driving electrode pairs at a location where the input occurs, when the determining unit determines that the input occurs.

9. The touch panel of claim 5, wherein a height of the plurality of spacers is less than a height of the sealant.

10. The touch panel of claim 9, wherein the sealant comprises:
a sealing dam which has a height which is the same as the height of the plurality of spacers and is disposed on the first substrate; and
a separation member which is positioned between the sealing dam and the second substrate and has a predetermined height.

11. The touch panel of claim 10, wherein the sealing dam and the plurality of spacers are made of a same material.

12. The touch panel of claim 5, wherein each of the plurality of spacers has a shape whose axial section is reduced with an increase in height.

13. A touch panel comprising:
a first substrate on which M first electrode lines are arranged in a first direction, wherein M is an integer greater than 2;
a second substrate separated from the first substrate and having N second electrode lines arranged in a second direction orthogonal to the first direction, wherein N is an integer greater than 2;
electro-rheological fluid which fills a gap between the first substrate and the second substrate;
a pulse generating circuit unit which generates a driving pulse voltage to drive the electro-rheological fluid and a sensing pulse voltage to determine whether an input on the touch panel occurs;
a pulse applying circuit unit which integrates the driving pulse voltage with the sensing pulse voltage and applies an integrated voltage to the M first electrode lines; and
a sensing circuit unit which measures capacitance at each of intersections of the M first electrode lines and the N second electrode lines in response to the sensing pulse voltage to determine whether the input occurs, wherein different criteria values are used to determine whether an input occurs.

14. The touch panel of claim 13, wherein the pulse applying circuit unit sequentially applies the sensing pulse voltage to the M first electrode lines while applying the driving pulse voltage to at least a portion of the M first electrode lines.

15. The touch panel of claim 13, wherein the sensing circuit unit comprises:
N voltage-to-current converters which converts one-by-one the N second electrode lines; and
a comparator which compares an output voltage from the N voltage-to-current converters to a reference voltage,
wherein the reference voltage is set based on the input type.

16. The touch panel of claim 15, wherein the input type is one of a click input and a continuous input, and
a reference voltage of the click input is greater than a reference voltage of the continuous input.

17. The touch panel of claim 13, wherein when the sensing circuit unit determines that the input occurs at at least one electrode line of the N second electrode lines, the pulse applying unit applies a driving voltage to the least one electrode line where the input occurs.

18. An electronic device including the touch panel of claim 1 as a user input device.

19. An electronic device including the touch panel of claim 5 as a user input device.

20. An electronic device including the touch panel of claim 13 as a user input device.

21. The touch panel of claim 5, wherein the plurality of spacers are disposed in an arbitrary distribution pattern on the first substrate.

22. The touch panel of claim 5, wherein the plurality of spacers have a conical shape.

23. The touch panel of claim 5, wherein the plurality of spacers have a polypyramid shape.
